(19) United States
(12) Patent Application Publication
(10) Pub. No.: US 2012/0077057 A1
(43) Pub. Date: Mar. 29, 2012

(54) Galvanostatic Dealloying for Fabrication of Constrained Blanket Nanoporous Gold Films

(76) Inventors: Jeffrey W. Kysar, New York, NY (US); Oya Okman, New York, NY (US)

(21) Appl. No.: 13/246,179

(22) Filed: Sep. 27, 2011

Related U.S. Application Data
(60) Provisional application No. 61/386,871, filed on Sep. 27, 2010.

(51) Int. Cl. C25F 3/02; B32B 5/18; B32B 15/01; C25F 1/00; C25F 7/00

(52) U.S. Cl. 428/613; 205/640; 204/242; 204/229.8; 205/50

(57) ABSTRACT

A system and method for fabricating a blanket metallic nanoporous film positioned a substrate in an electrochemical cell using a galvanostatic dealloying method where areal current density is directly controlled and the process is terminated when the potential reaches a predetermined cut-off value. A blanket metallic nanoporous film attached to a substrate that is substantially crack free, has a bicontinuous porous structure with the interconnecting ligaments having a length scale from 10 nm to 30 nm, and has a continuous interconnected porous region having a length scale from 10 nm to 30 nm.

### CROSS-REFERENCE TO RELATED APPLICATIONS

This application is related to U.S. Provisional Application Ser. No. 61/386,871, filed Sep. 27, 2010, which is incorporated herein by reference in its entirety and from which priority is claimed.

### STATEMENT REGARDING FEDERALLY SPONSORED RESEARCH OR DEVELOPMENT

This invention was made with government support under Award No. 0826093 awarded by the National Science Foundation. The government has certain rights in the invention.

### BACKGROUND

The disclosed subject matter is directed to the fabrication of blanket nanoporous metallic films adhered to substrates, which can provide a substantially uniform, crack-free, nanoporous film structure over a projected area.

Nanoporous gold (NPG) is a bicontinuous network of ligaments and pores with the ligament sizes varying from 3 to 50 nm, with a surface area to mass ratio as high as 120 m²/g, and is chemically stable. NPG films can be suitable for a number of applications, including in MEMS devices, sensors, actuators, and catalysts.

NPG can be prepared by a process called dealloying, in which the less noble element of a precursor gold (Au) alloy is removed selectively in a corrosive environment or by an electrochemical cell at a controlled applied potential. For example, NPG can be prepared from gold-silver (Au/Ag) alloys by selective dissolution of the silver (Ag). Additionally, NPG can be prepared where more than two alloying metals are added to the precursor alloy, such as a ternary alloy or alloy with greater number of constitutions, with progressively increasing electrochemical nobilities of the alloy constituents.

A NPG thin film can develop cracks through its thickness during dealloying of the precursor alloy (e.g., Au/Ag) if the alloy film is constrained to an underlying substrate. Such cracks, for example, as shown in FIG. 5 (14, 17) can arise due to the large tensile stress that develops as a consequence of preventing the volumetric film shrinkage, which is commonly observed in unconstrained films when Ag atoms are selectively removed from the film. On the other hand, the spinodal decomposition based evolution of the nanoporous structure involves diffusion of the Au on the film surface, which can lead to reduction of stress within the film, Thus, the propensity for cracking in an NPG film is related to the competition between the rate of stress increase due to removal of the Ag atoms and the rate of stress relief by the surface diffusion of Au.

Dealloying processes can be performed in an electrochemical cell while controlling the applied electric potential. An electric current is observed in the cell if a sufficiently high positive potential is applied. If there are no other reactions occurring in the cell, the current represents the rate of removal of Ag from the precursor alloy, and hence the rate of increase of film stress. However, control of the potential in the electrochemical cell (e.g., potentiostatic dealloying) provides only indirect control over the rate of Ag removal, and can result is undesired increase in the film stress, which may result in cracks. Accordingly, there exists a need for an improved technique to produce blanket crack-free NPG films.

### SUMMARY

The presently disclosed subject matter provides techniques for directly controlling the electric current and the rate of Ag removal so that blanket crack-free NPG films adhered to silicon substrates are fabricated. In some embodiments, a three-electrode electrochemical cell is utilized to directly control the Ag removal rate and maintain it at a sufficiently low rate to avoid cracking in such blanket NPG films.

In some embodiments, a method for fabricating blanket nanoporous metallic films constrained to substrates includes applying a film of precursor alloy on a silicon substrate, dealloying the film in an electrochemical cell by controlling the areal current density and terminating the dealloying process when the potential reaches a predetermined cut-off value. The precursor alloy, which in some embodiments can be an Au/Ag alloy applied either by deposition or by manual attachment to a silicon substrate, can be placed on the anode of a three-electrode electrochemical cell. The projected area of the Au/Ag alloy can be determined precisely prior to the dealloying by, for example, standard lithographic methods.

In some embodiments, the counter electrode can be a platinum mesh, the reference electron can be an Ag/AgCl reference electrode and the electrolyte can be a 0.7 M perchloric acid solution. The precursor alloy can have a gold concentration of between 26% at. Au and 35% at. Au, and can be a thin film with thickness of up to 1300 nm and adhered to a stiff substrate.

During operation of an exemplary cell, the less noble metallic element dissolves in high amounts as the cell potential exceeds a critical potential, which lies between the oxidation potentials of the two metals, and can be expressed as a function of the alloy composition. In some embodiments, a potentiostat is used to keep the areal current density and the dissolution rate of the less noble element in the cell at a controlled value throughout dealloying.

In some embodiments, a galvanostatic method provides a substantially uniform areal current density at a level sufficiently low to keep the stress build up on the films below a critical value at which the cracks form. The potential necessary to remove the required amount of Ag can increase throughout the dealloying process, due to depletion of Ag, and the process can be terminated as the potential reaches a predetermined cut-off potential value. The Ag removal rate and the cut-off value are process parameters that can be determined so as to inhibit crack formation and obtain the required residual Ag.

In some embodiments, NPG produced in accordance with the subject matter disclosed herein can have a bicontinuous porous structure in which the interconnecting gold ligaments have a length scale that can be tuned with an exemplary galvanostatic method from 10 nm to 30 nm. Further, the continuous interconnected porous region can also have comparable length scales. In some embodiments, the surface area to mass ratio of NPG can be as high as 10 m²/g, which makes the material useful for any process that requires a high propensity of surface area, such as catalysis. The NPG can also have properties where a change in the surface stress induces a measureable change in the volume. The change in surface stress can also be induced via chemical reaction on the surface, so the NPG can serve as a means to detect the presence of such chemical species.

In some embodiments, the NPG can be deposited onto free standing microscale mechanical structures, such as cantilever beams, to produce devices. Further, such an exemplary device can serve as a microscale actuator, microscale sensor or a device to scavenge energy from mechanical vibrations, among other applications.

Accordingly, subject matter disclosed herein provides techniques for fabrication of robust, crack-free NPG films adhered to silicon substrates at thicknesses up to 1300 nm. Further, the systems and methods disclosed herein can be utilized to create microscale devices by, for example, incorporating NPG on silicon. MEMS devices.

### BRIEF DESCRIPTION OF THE DRAWINGS

FIG. 1 shows a schematic representation of preparation of one embodiment of the presently disclosed subject matter: (a) sputtering of Cr and Au; (b) spin coating of the photoresist; (c) exposure through a photomask; (d) developing; (e) sputtering of Au/Ag alloy; (f) lift off; and, (g) dealloying.

FIG. 2 shows a schematic representation of a three-electrode electrochemical cell.

FIG. 3 shows variation of potential in galvanostatic dealloying for an NPG thin film fabricated from dealloying at constant areal current density of 2.5 mA/cm² from a precursor alloy film of 30 at. % Au and initial thickness of 250 nm.

FIG. 4 shows the potential and current history prepared using: (a) potentiostatic dealloying with ramped potential increase; and, (b) galvanostatic dealloying. The precursor alloys used has 250 nm thickness with an initial composition of 34 at. % Au.

FIG. 5 shows the potential and current history and resulting NPG structure of 1300 nm NPG films from 32 at. % Au precursor alloy: (a) potentiostatic method with stepped potential; (b) potentiostatic method with ramped potential; and, (c) galvanostatic method with constant current density of 3 mA/cm².

FIG. 6 shows potential history for 1.5 mA/cm² current density in galvanostatic dealloying of a 1300 nm thick precursor of 32 at. % Au to achieve a crack-free NPG film with lower residual Ag content.

### DETAILED DESCRIPTION

The subject matter disclosed herein provides a system and method for fabrication of high quality crack-free NPG films attached to a substrate using a galvanostatic dealloying method in an electrochemical cell. Some embodiments of the disclosed subject matter enables the fabrication of constrained NPG films with a thickness of up to 1300 nm and beyond, with precursor alloys having a gold concentration of between 26% at. Au and 35% at. Au.

Nanoporous metallic films can be fabricated by selective dissolution of the less noble element in a binary solid solution alloy, typically an Au/Ag alloy, that has complete solid solubility of the two elements. Selective removal of the Ag atoms can be realized either by free corrosion or by dealloying with an electrochemical cell. Both methods provide crack-free NPG materials from precursor alloys in the form of unconstrained thin leafs and millimeter scale ingots. However, when blanket films of Au/Ag alloy are constrained to a substrate, significant cracking can occur where a potentiostatic electrochemical dealloying method is used due to the large tensile stress that develops as a consequence of the volumetric film shrinkage, which is a function of Ag atoms being selectively removed from the film.

The overall shrinkage of unconstrained alloy films upon removal of one component has been experimentally shown in literature. Upon dealloying, the change in edge length of an unconstrained Au/Ag alloy leaf, ΔL/L, can be as large as 10%, leading to a relative volumetric change ΔV/V of up to 30%. If the precursor film is adhered to a stiff substrate such as silicon, the constrained volume reduction translates into internal film stress. On the other hand, acidic environment and high voltage enhances surface diffusion of Au and results in stress relief.

For a constrained precursor film, a tensile stress develops in the film because the value of strain, ε=ΔL/L, is constrained to remain very small. An upper bound for the mean biaxial stress, σₘ, in the NPG film is σₘ≦M_{f}ε_{unc}, where M_{f} is the biaxial modulus of the NPG defined as M_{f}=E_{f}/(1−v_{f}), and ε_{unc} is the strain in an unconstrained film; here E_{f} is Young's modulus and v_{f} is Poisson's ratio of the NPG film. The high strain energy densities that can result from a ε_{unc} of 30% would certainly cause the film to fracture, especially since it can exhibit macroscopic brittleness. Therefore, to obtain a crack-free NPG film, dealloying procedures should maintain d_{surf} much smaller than it would be for dealloying in an unconstrained state. The value of σₘ that develops in the constrained films upon dealloying is related to the ΔL/L that occurs during constrained dealloying, here called ε_{unc}. Clearly then ε_{unc}=σₘ/M_{f}. The value of σₘ can be as high as 90 MPa, which corresponds to a value of ε_{unc} up to 0.008 based upon E_{f}=8.8 GPa and assuming a Poisson's ratio of v_{f}=0.2.

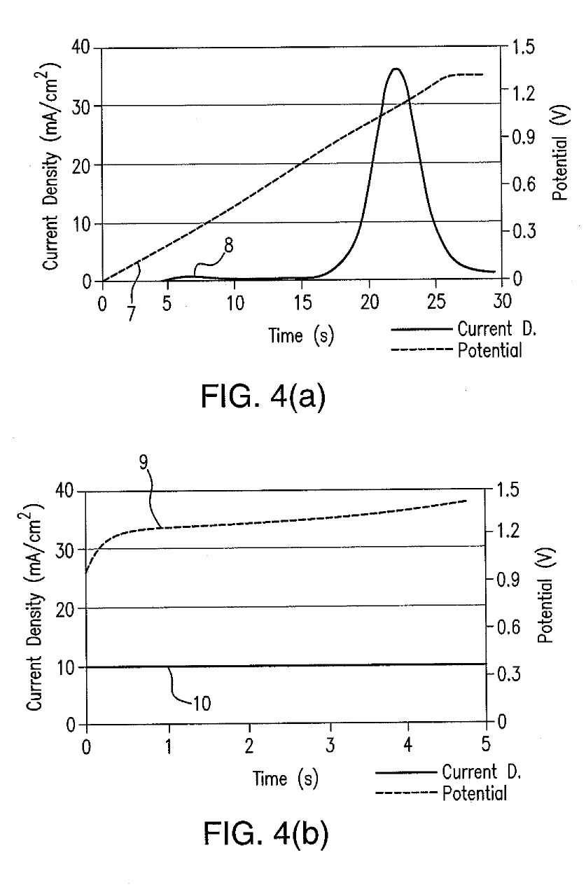

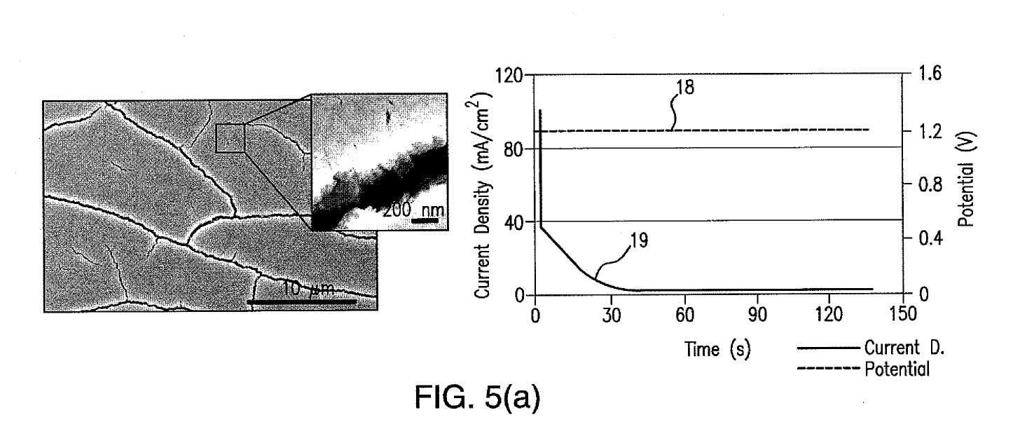

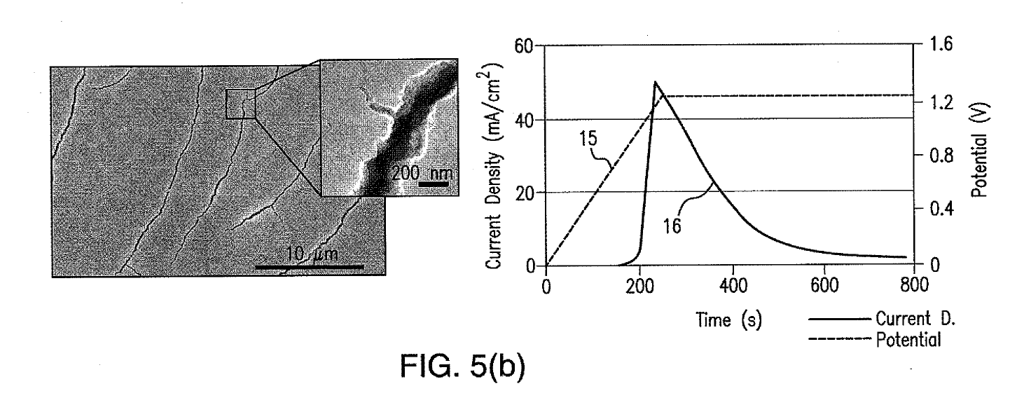

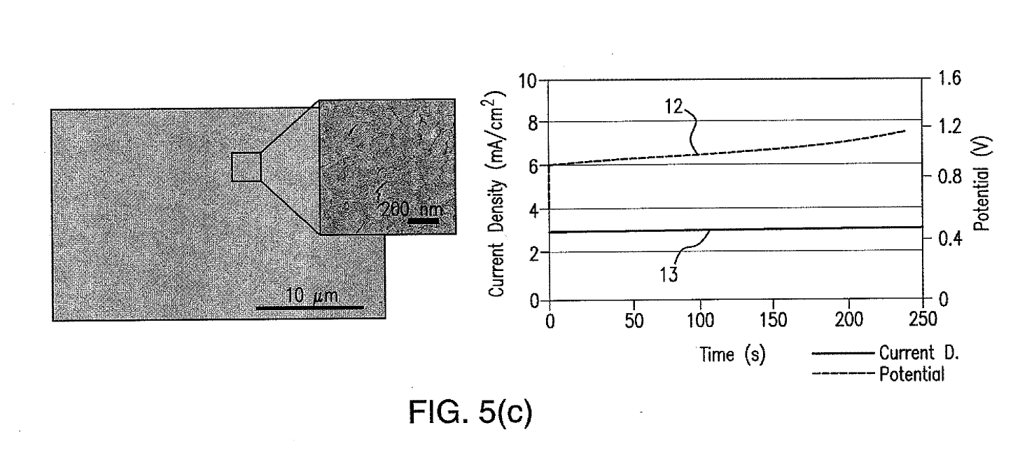

In potentiostatic dealloying, the electric potential, shown in FIGS. 4 and 5 (7, 15, 18), (i.e voltage) is controlled throughout the dealloying process and electric current, as shown in FIGS. 4 and 5 (8, 16, 19), adopts a value determined by the potential and the electrochemical circuit. The electric current is directly related to the rate at which Ag+ ions are removed from the alloy film on the anode of the electrochemical cell. Using a potentiostatic dealloying process wherein the electric potential is applied both as a step function, shown in FIG. 5 (18), and as a ramp function, shown in FIGS. 4 and 5 (7, 15) creates a highly non-uniform current density (8, 16, 19). For example, one study on potentiostatic dealloying of NPG films reported that for a potential of 1.2 V (vs Ag/AgCl reference electrode) applied as a step function, the current density is initially as high as 400 mA/cm² and reduces to a value two orders of magnitude smaller as the dealloying continues (See O. Okman and J. W. Kysar. Fabrication of crack-free nanoporous gold blanket thin films by potentiostatic dealloying). The maximum current density during ramped application of the potential was about 14 mA/cm² (which occurs at a potential of about 1 V (vs Ag/AgCl reference electrode) and then reduced rapidly due to depletion of the Ag in the remaining precursor alloy to a value of about 2 mA/cm² (Id.). Thus, the Ag dissolution rate can be temporally highly non-uniform for both potential-controlled schemes. Any increase in Ag dissolution rate can be accompanied by a concomitant elevation of the stress level, so the ramped potential scheme is expected to yield better quality NPG thin films constrained to a substrate than the stepped potential scheme.

As mentioned, there is a competition between the internal tensile stress created by Ag dissolution and reduction in stress provided by Au surface diffusion. The internal tensile stress is relieved, via what is believed to be a coble creep mechanism, the film stress is decreased due to Au surface diffusion. Au diffusion is enhanced by the instantaneous stress state as well as the dealloying parameters. Spreading the total Ag dissolution to a longer time period allows more Au surface diffusion to occur. Thus, in potentiostatic methods, applying low potentials around the critical dealloying potential (at which a sustainable Ag dissolution is achieved), the risk of cracking is reduced. However, the residual Ag is high and the process can take as long as 10 hours. Increasing the potential enhances Au surface diffusion. However, at high dealloying potential Ag dissolution rate is also high and the accompanying stress increase is generally not compensated in potentiostatic methods. Films crack severely in most cases. Coarsening can also be achieved in a variety of techniques unrelated to the fabrication of NPG films.

There are a number of additional drawbacks to using a potentiostatic dealloying method. Cracking can be a concern where the film alloy is constrained to a substrate. Cracking can be further exacerbated when the conditions of the film are changed. For example, thicker films (more than 250 nm) are more likely to crack with a potentiostatic method. This is because the greater thickness allows a greater elastic strain energy to be stored in the film which can be released subsequently as a driving force for the growth of cracks and other defects. Additionally, films created from precursor alloys with lower concentrations of gold (for example, 26% at. Au) increase the likelihood of cracking. This is due to the increased volumetric reduction of the Au/Ag alloy where more Ag is removed.

In addition to cracking, potentiostatic dealloying methods can take a longer amount of time to reach a desired level of silver concentration. It can take as long as 10 hours to reach a level of below 2% at. Ag. Because potentiostatic methods take so long, there is also a likelihood of increased coarsening.

The present disclosure provides techniques to produce high quality crack-free blanket nanoporous metallic films constrained to a substrate by controlling the areal current density during dealloying (i.e., galvanostatic dealloying). The term “blanket film” refers to thin films adhered to the underlying substrate and its thickness is a few orders of magnitude smaller than its lateral dimensions. The use of galvanostatic dealloying ameliorates the drawbacks of potentiostatic dealloying by controlling the precise dissolution rate of the less noble of the metals in the alloy throughout the dealloying process. The areal current density can be directly controlled, for example, during dissolution of Ag from an Au/Ag precursor alloy in aqueous perchloric acid electrolyte.

Unlike potentiostatic dealloying, which creates highly temporally non-uniform areal current density, galvanostatic dealloying can directly control the areal current density, and thus the rate of removal of Ag from the precursor alloy. Maintaining the rate of removal of Ag from the precursor alloy at sufficiently low levels can avoid the buildup of tensile stress and the concomitant elastic strain energy, and thus avoid cracking. Additionally, the galvanostatic method disclosed herein reduces the dealloying time to a matter of minutes rather than hours. The total dealloying time is then at an optimum value, to avoid cracking and prevent excessive coarsening of the nanoporous structure. To achieve increased coarsening with the galvanostatic method described herein, the NPG film can be left in the electrochemical cell at a cut-off potential for a specified period of time.

The techniques disclosed herein to produce high quality crack-free blanket NPG films can also be applied to a variety of metallic film alloys, so long as there is no other reaction within the cell within the ranges of potential that are used. The alloys are not limited to binary solid solutions. Additionally, the galvanostatic method disclosed herein can also be applied to bulk alloys instead of films attached to substrates. All embodiments throughout this disclosure, while they can be directed to NPG films, are intended to be non-limiting and the methods disclosed herein are equally applicable to other metallic alloy films as well as bulk alloys.

The blanket nanoporous metallic films are produced starting with an alloy of prescribed composition. The alloy includes elemental metals of prescribed composition with a large difference in electrochemical activity, where the application of an appropriate electrochemical potential in a suitable electrolyte the reactive element can be selectively dissolved out while leaving the more noble element. In some embodiments of the presently disclosed subject matter, an Au/Ag alloy is used as the starting, or precursor, alloy. The Au/Ag alloy can have a gold concentration of between 26% at. Au and 35% at. Au.

The metallic alloy is then attached to a substrate. Attaching the metallic alloy to a substrate is important in the fabrication of MEMS devices, where the resulting nanoporous film acts as the functionalized layer. In some embodiments, the substrate can be a silicon substrate. The metallic alloy can be attached through a variety of methods, including chemically depositing the alloy onto the substrate, vapor depositing the alloy onto the substrate as well as manual attachment. In some embodiments of the presently disclosed subject matter, an adhesive layer is first deposited onto the silicon substrate using a sputtering method so as to prevent delamination of the alloy film. In these embodiments, the metallic alloy is then deposited onto the adhesive layer. For a precursor alloy consisting of Ag/Au, an adhesive bilayer of Cr and Au can be used. In alternative embodiments, the metallic alloy can be manually attached to the substrate using an appropriate adhesive polymer.

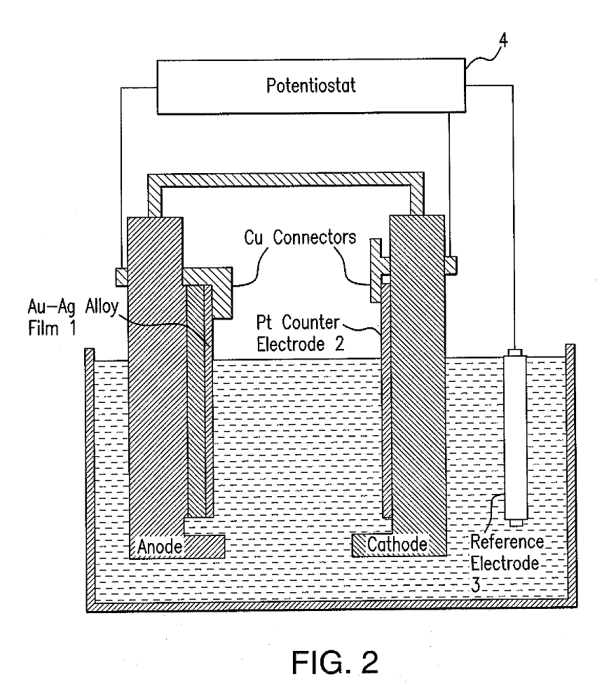

The metallic alloy attached to the substrate (collectively, “the sample”) is then placed in an electrochemical cell. In some embodiments of the presently disclosed subject matter, the electrochemical cell can be a three-electrode electrochemical cell. Where the precursor alloy is an Au/Ag alloy, the electrolyte in the electrochemical cell can be perchloric acid at a concentration of 0.7 M. The counter electrode can be a Pt counter electrode and the reference electrode can be an Ag/AgCl electrode. Further, the counter electrode can be a 2 cm² platinum electrode mesh. The Au/Ag alloy is placed on the anode. FIG. 2 shows a schematic representation of a three-electrode electrochemical cell used in some embodiments of the presently disclosed subject matter.

The sample in the electrochemical cell is then dealloyed using a galvanostatic method. Such a method is one in which the areal current density is directly controlled, as opposed to a potentiostatic method wherein the potential is directly controlled. The areal current density is the current density in relation to the area of the face of a prescribed volume of metallic alloy. Note that areal current density does not refer to the total surface area of the metallic alloy but rather the area of a face of a prescribed volume of such alloy. In some embodiments of the presently disclosed subject matter, the areal current density is controlled with the use of a potentiostat so as to maintain a substantially constant areal current density. The value of the areal current density necessary to fabricate crack free nanoporous metallic film depends on the thickness of the precursor alloy. In general, thicker precursor alloys crack at a lower film stress and thus require a lower areal current density to result in crack-free nanoporous films. In some embodiments the areal current density is maintained at a value of up to 3 mA/cm². A crack-free blanket NPG film produced from an Au/Ag precursor alloy of 1300 nm thickness can be achieved with an areal current density of 3 mA/cm². An areal current density of 10 mA/cm² resulted in cracking of a 1300 nm Au/Ag precursor alloy with 30% at. Au. The maximum areal current density can be increased in thinner films.

In other embodiments of the presently disclosed subject matter, the areal current density can be maintained in other functional forms. For example, the areal current density can be maintained as a step function.

The dealloying process is terminated when the potential reaches a predetermined cut-off value. The cut-off value is chosen such that the potential remains below the oxidation potential of the more noble element so that the more noble element is not removed from the film, and thus essentially all current in the electrolyte can be attributed to the less noble element ions. For example, if the precursor alloy is an Au/Ag alloy, the cut-off value will be chosen at a potential that is below the oxidation potential of Au so that Au is not removed from the film. In some embodiments, the cut-off value can be between 1.00 V and 1.45 V (vs Ag/AgCl reference electrode). With a precursor alloy being an Au/Ag alloy and the electrolyte being perchloric acid of 0.7 M concentration, these values can achieve a residual Ag rate of less than 2%. In some embodiments, the cut-off value can be set to be slightly higher than the potential at which an monolayer of oxide forms on the surface of the more noble element. When an oxide layer forms on the surface of the more noble element, surface diffusion is prevented. With known potentiostatic methods, cracking generally occurs as a combined result of the lack of surface diffusion and uncontrolled discharge of the Ag atoms leading to an abrupt increase in the film stress. In some embodiments, the cut-off potential can be set at a value above this potential whereby the potential of monolayer oxide formation is exceeded only towards the end of the completion of dealloying, at which point the porous structure is partly formed and the internal film stress increase is lower than that would be observed in case of potentiostatic methods with step or ramp potential application, operated above the potential of monolayer oxide formation. Risk of film cracking is considerably reduced.

By employing a galnvanostatic method in accordance with the embodiments described above, dealloying is completed on the order of second or minutes, as opposed to on the order of hours as with potentiostatic dealloying methods. Additionally, films up to 1300 nm thickness and beyond can be fabricated without cracks. Precursor Au/Ag alloys with a gold concentration of as low as 26% at. Au can also be used in fabricating crack free blanket NPG.

### EXAMPLE

### Example 1

The methods of one embodiments of the presently disclosed subject matter were employed for the production of blanket nanoporous metallic films disclosed herein as follows:

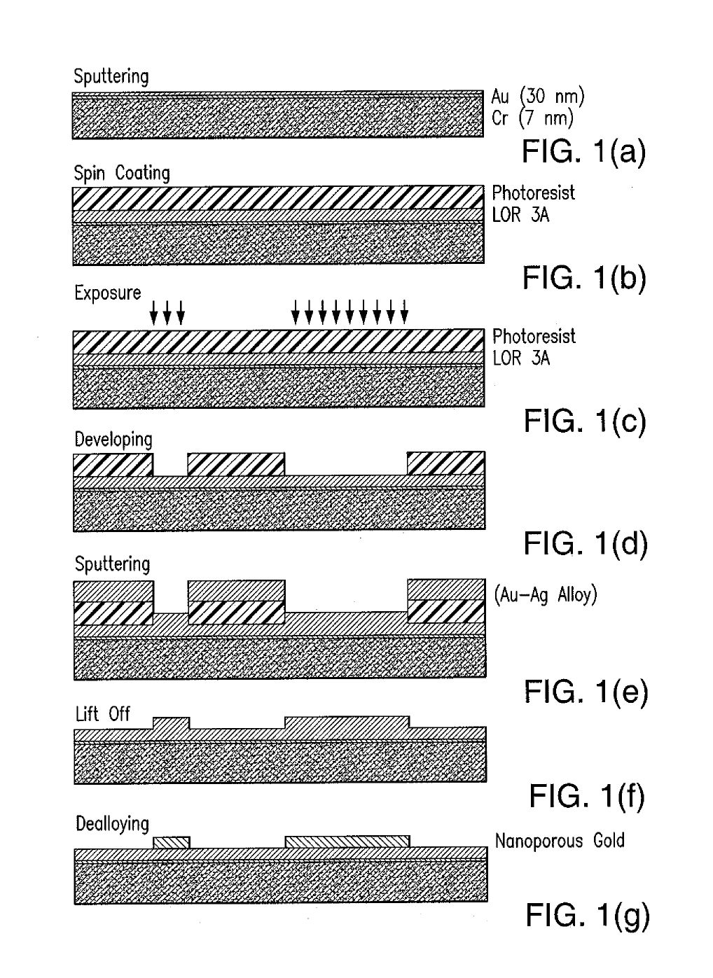

Prior to deposition of the precursor alloy film, silicon substrates were cleaned in acetone (Phramco-Aaper) in a sonicator for 5 minutes, then rinsed with isopropanol (99.8% pure Pharmco-Aaper), and finally baked at 150° C. on a hot plate for 10 minutes. Adhesion layers of 7 nm Cr and 30 nm Au were deposited by sputtering, at a base pressure of 2×10⁻⁶ Torr of Ar in a vacuum deposition system (Kurt J. Lesker PVD 75) (FIG. 1(a)).

The Au layer serves two purposes: as a barrier to isolate the underlying Cr film from the electrolyte to prevent delamination; and, as a conductive layer to transmit current to the alloy during electrochemical dealloying. The regions of the Au/Ag precursor alloy were prepared using photolithography as demonstrated in FIG. 1. After deposition of the adhesion layers, the samples were spin coated with LOR 3A (MicroChem Inc.) resist and then with Microposit S1813 (Shipley Company) photoresist. The resist bilayer (FIG. 1(b)) improves the integrity of the patterns during the lift off (FIG. 1(f)). The samples were then exposed using either a Heidelberg μPG 101 laser writer or a Suss MicroTec MJB3 Mask Aligner (FIG. 1(c)). The sample pattern to be dealloyed was comprised of a rectangular region with an area that ranges from 6 mm² to 16 mm². The samples were then placed in a sputter deposition system and coated with and Au/Ag alloy of 30 at. % Au with an initial thickness of 250 nm using simultaneous sputter deposition of the Au and Ag. The resist was then removed using NANO™ Remover PC (MicroChem Corp.), leaving behind precisely patterned rectangular islands of Au/Ag alloy on an Au coated surface (FIG. 1(f)). The photolithography methods used to pattern the surface provide dimensional accuracy of the order of micrometers.

The precursor Au/Ag alloy films were dealloyed using a three-electrode electrochemical cell, with a Pt counter electrode (2) and an Ag/AgCl reference electrode (3) (FIG. 2). A potentiostat (4) (μAutolab® Type III/FRA2) was used to control the current. Herein, potentials are reported versus the reference electrode (3) (0.200 V versus SHE). Aqueous perchloric acid (0.7 M) at 60° C. was used as the electrolyte. A 2 cm² platinum electrode mesh was used as the counter electrode (2), which was placed at a distance of 3 mm from the alloy film surface. Areal current density values were calculated based on the measured current history normalized by the projected area of the patterned Au/Ag island onto the substrate. Process parameters were chosen such that the potential remains below the oxidation potential of the Au so that Au is not removed from the film; thus essentially all current in the electrolyte can be attributed to Ag+ ions.

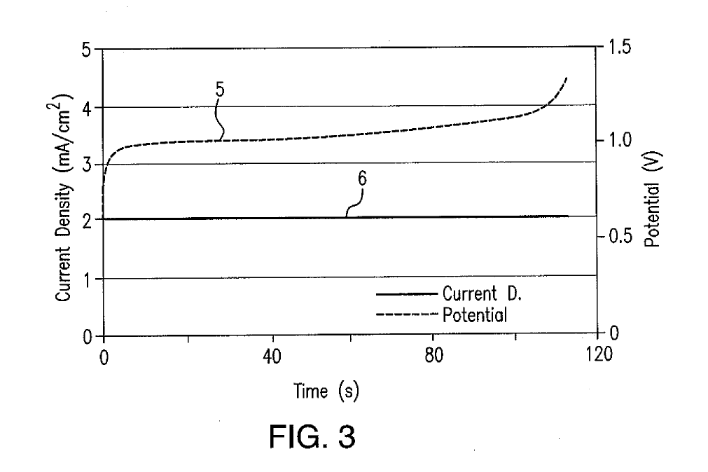

Using a galvanostatic method, the applied potential was regulated by a potentiostat (4) to maintain a constant current density of 2.5 mA/cm² during dissolution of Ag from the precursor alloy and the attendant morphological changes that occur. FIG. 3 shows the variation of potential (5) and the constant current density (6) over time. The corresponding potential (5) at any instant is a function of the morphology of the developing NPG structure as well as the residual Ag that remains in the film. Once the Ag concentration in the film nears depletion, the potential (5) must increase to maintain a constant current density (6). The steep increase of the potential (5) towards the end of the process in FIG. 3 indicates almost complete dissolution of Ag atoms in the alloy and therefore low residual Ag concentration in the final NPG film. If the process were to continue unabated, the potential would increase to the level at which Au dissolution would occur. Since Au dissolution is not desired, the galvanostatic process is set to terminate when the potential exceeds a cut-off value, V_{co}. The cut-off value is an important process parameter that must be determined for each alloy composition. In this embodiment, the cut-off potential was set to be 1.3 V.

### Example 2

The methods of another embodiment of the presently disclosed subject matter were employed in the production of blanket nanoporous metallic films as follows:

Precursor alloy films with initial thickness of 250 nm and initial composition of 34 at. % Au were deposited onto silicon substrates with the Cr adhesion layer as described above in Example 1. The predetermined current density for the galvanostatic method was chosen to be 10 mA/cm². The predetermined cut-off value for the galvanostatic method was chosen to be 1.45 V. The total time necessary for the dealloying process to come to completion was about 5 s for the galvanostatic method. This can be important because, in principle, the NPG ligament and pore sizes coarsen with longer dealloying times.

FIG. 4 shows potential (9) and current density (10) history for the galvanostatic method employed in this embodiment.

### Example 3

The methods of another embodiment of the presently disclosed subject matter were employed in the production of blanket nanoporous metallic films as follows:

Precursor alloy films with initial thickness of 1300 nm and initial composition of 32 at. % Au were deposited onto silicon substrates with the Cr adhesion layer as described above in Example 1. The predetermined current density for the galvanostatic method was chosen to be 3 mA/cm². The predetermined cut-off value for the galvanostatic method was chosen to be 1.2 V. The total time necessary for the dealloying process to come to completion was about 250 s for the galvanostatic method.

The film was then imaged using a Hitachi 4700 Scanning Electron Microscope (SEM) at a working distance of around 8 mm, with an acceleration voltage of 10 kV and a beam current of 10 mA. FIG. 5 shows the image (11) of the resulting film and the potential (12) and current density (13) history for the galvanostatic method used in this embodiment.

### Example 4

The methods of another embodiment of the presently disclosed subject matter were employed in the production of blanket nanoporous metallic films as follows:

Precursor alloy films with initial thickness of 1300 nm and initial composition of 32 at. % Au were deposited onto silicon substrates with the Cr adhesion layer as described above in Example 1. The predetermined current density for the galvanostatic method was chosen to be 1.5 mA/cm². The predetermined cut-off value for the galvanostatic method was chosen to be 1.45 V. The total time necessary for the dealloying process to come to completion was about 600 s.

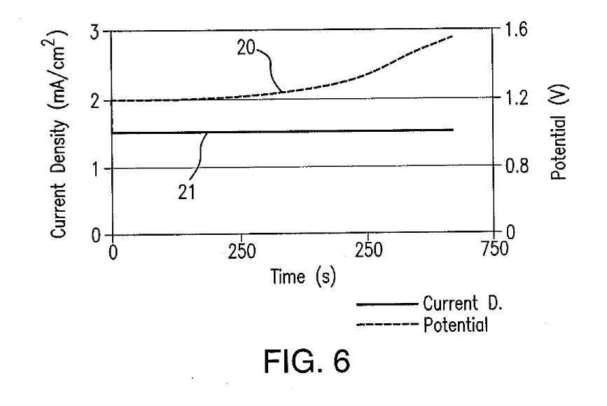

FIG. 6 shows potential (20) and current density (21) history for the galvanostatic method employed in this embodiment.

With only a few exemplary embodiments of the presently disclosed subject matter have been described in detail, those skilled in the art will recognize that there are many possible variations and modifications which can be made in the exemplary embodiments. Accordingly, it is intended that the following claims cover all such modifications and variations.

We claim:

1. A method for fabricating a blanket metallic nanoporous film in an electrochemical cell, comprising:
a) applying a film of a metallic alloy on a substrate;
b) dealloying said film in said electrochemical cell by controlling current areal density applied thereto to generate a dealloyed film.

2. The method of claim 1, further comprising:
a) measuring a potential across said film; and
b) terminating said dealloying when said measured potential reaches a predetermined cut-off value.

3. The method of claim 1, wherein said film comprises a gold (Au) and silver (Ag) alloy.

4. The method of claim 3, wherein said applying comprises deposition.

5. The method of claim 3, wherein said applying comprises manual application.

6. The method of claim 3, wherein said film comprises an alloy with more than two constituents, where each constituent has progressively increasing electrochemical nobilities.

7. The method of claim 3, wherein said film of metallic alloy comprises a film up to 1300 nm thick.

8. The method of claim 1, wherein said substrate comprises a silicon substrate, and further comprising, prior to said applying, attaching an adhesive layer to said silicon substrate, such that said film is applied to said adhesive layer.

9. The method of claim 1, wherein said dealloying further comprises placing said film in said electrochemical cell, wherein said electrochemical cell includes perchloric acid.

10. The method of claim 8, wherein said perchloric acid comprises perchloric acid in a concentration of 0.7 M.

11. The method of claim 1, wherein controlling said current areal density comprises maintaining said current areal density to be substantially constant at a predetermined level sufficiently low to avoid cracking.

12. The method of claim 2, wherein said predetermined cut-off value is set at a level within a range bounded by an upper bound so as to avoid dissolution of the more noble element in the metallic alloy and a lower bound so as to achieve a desired residual silver concentration.

13. A system for fabricating a blanket metallic nanoporous film from a film of a metallic alloy positioned on a substrate, comprising:
a) an electrochemical cell adapted for receiving said film of a metallic alloy and an electrolyte;
b) a current source, electrically coupled to said electrochemical cell, for providing a substantially constant areal current density to said electrochemical cell;

14. The system of claim 13, further comprising:
a) a device capable of measuring potential coupled to said electrochemical cell, for measuring a potential therein; and
b) control, coupled to said current source and said potentiometer, for turning said current source off when said device measures a potential at a predetermined cut-off value.

15. The system of claim 13, wherein said electrochemical cell comprises a three-electrode electrochemical cell including a Pt counter electrode and an Ag/AgCl reference electrode.

16. The system of claim 13, wherein said substrate is a silicon substrate.

17. The system of claim 13, wherein said substrate is a free standing microscale mechanical structure.

18. A blanket metallic nanoporous film positioned on a substrate comprising:
a) a substrate;
b) a substantially crack-free blanket metallic nanoporous film comprising a bicontinuous porous structure with interconnecting ligaments having a length scale from 10 nm to 30 nm, and a continuous interconnected porous region having a length scale from 10 nm to 30 nm, positioned on said substrate.

19. The film of claim 18, wherein said substrate is a silicon substrate, and said film is constrained to said substrate.

20. The film of claim 18, wherein said film comprises a film having a thickness of more than 250 nm.
